(19) United States
(12) Patent Application Publication
(10) Pub. No.: US 2010/0258465 A1
(43) Pub. Date: Oct. 14, 2010

(54) HINGED CASE FOR A SET OF TOOLS, ESPECIALLY FLAT-HANDLED SPANNERS

(75) Inventor: Herve Gomas, Saint Fargeau (FR)

Correspondence Address: YOUNG & THOMPSON, 209 Madison Street, Suite 500, Alexandria, VA, 22314, US

(73) Assignee: STANLEY WORKS (EUROPE) AG, Dubendorf (CH)

(21) Appl. No.: 12/676,023

(22) PCT Filed: Sep. 2, 2008
(86) PCT No.: PCT/FR2008/051559

§ 371 Date: May 5, 2010

(30) Foreign Application Priority Data
Sep. 3, 2007 (FR) 07 57324

(51) Int. Cl. B25H 3/00; B25B 13/56

(52) U.S. Cl. 206/378; 81/176.1

(57) ABSTRACT

This case (10) for a set of tools provided with a handle comprises a first holder (17) and a second holder (18) which are hinged together by a hinge (19) between a first position and a second position, and the holders (17, 18) comprise two partitions (24) which are substantially parallel to one another and which define a channel (22) intended to receive and retain the handle of a tool, each housing comprising two partitions (24, 124) substantially parallel to one another defining a channel (22, 122) intended to receive and retain the handle (16) of a tool. Each channel has a slightly greater width than the smallest dimension of the handle (16) of the associated tool, the handle being arranged substantially vertically in each channel. Application to the storage of a set of open-ended spanners or ring spanners.

The present invention relates to a case for a set of tools, in particular for open-end spanners or ring spanners, each tool comprising at least one working head and a flat handle, the case being of the type described in the preamble of claim 1.

Hand tools are generally marketed as a set of tools disposed on a rack, which rack is subsequently used, in maintenance workshops, for storing the set of tools and checking that all the tools in the set are present on the rack.

It is known from U.S. Pat. No. 6,896,136 to manufacture such a spanner rack from two separate rack elements, each element comprising a base from which receivers extend for keeping the tool handles flat. The rack elements are hinged with each other so that the elements are superposed in the storage and transport position.

However, such a design does not allow the set of tools to be stored compactly in the user's pocket, does not give ready access to the tools and does not have a low manufacturing cost.

The object of the invention is to optimise the compactness of a case for a set of tools while improving the accessibility of the set of tools and benefiting from a low cost.

To that end, the invention relates to a case for a set of tools of the above-mentioned type, characterised by the characterising part of claim 1.

Accordingly, the invention ensures that the set of tools has a minimal space requirement and permits ready access to the tools.

Other embodiments are described in claims 2-12.

The invention relates also to a tool set comprising a set of tools arranged in a case as defined hereinbefore.

The invention and its advantages will better be understood upon reading the following description, which is given solely by way of example and with reference to the accompanying drawings, in which:

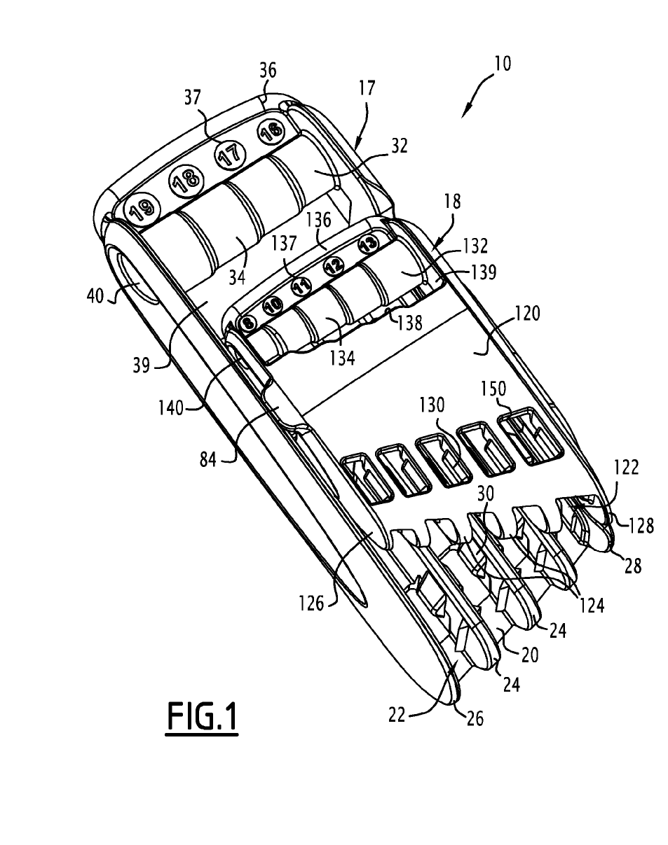

FIG. 1 is a perspective view of a case for a set of tools according to the invention, showing the case in the storage and transport position;

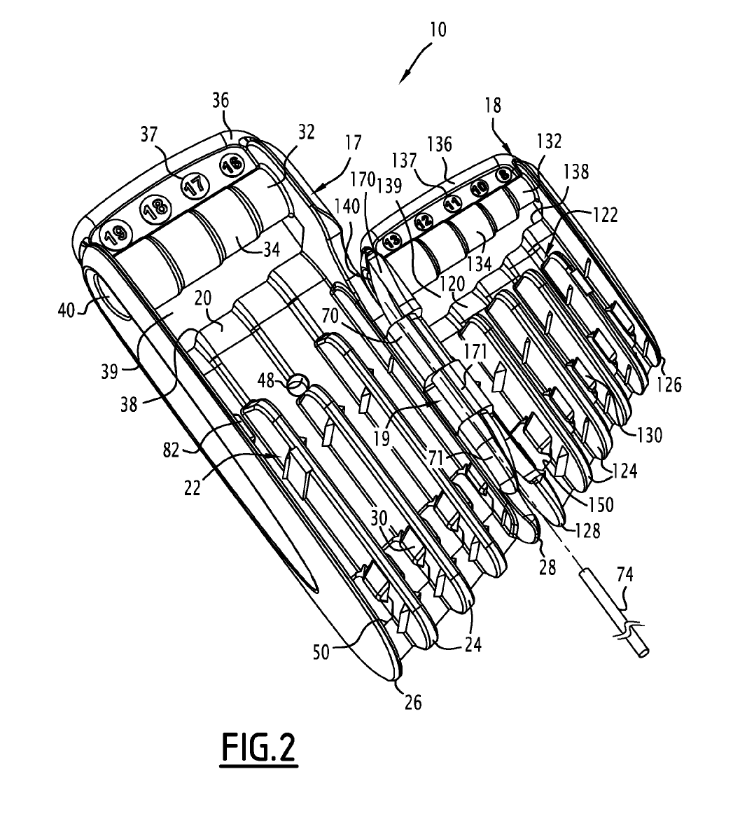

FIG. 2 is a perspective view of the case for a set of tools represented in FIG. 1, showing the case in the position giving access to the set of tools;

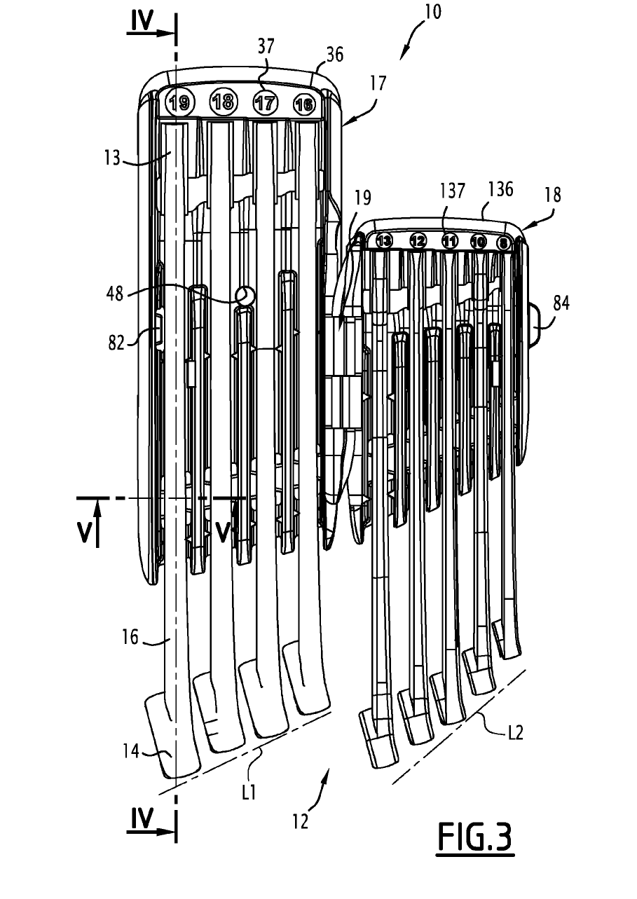

FIG. 3 is a front view of the case for a set of tools represented in FIG. 2, the tools being in place on the support;

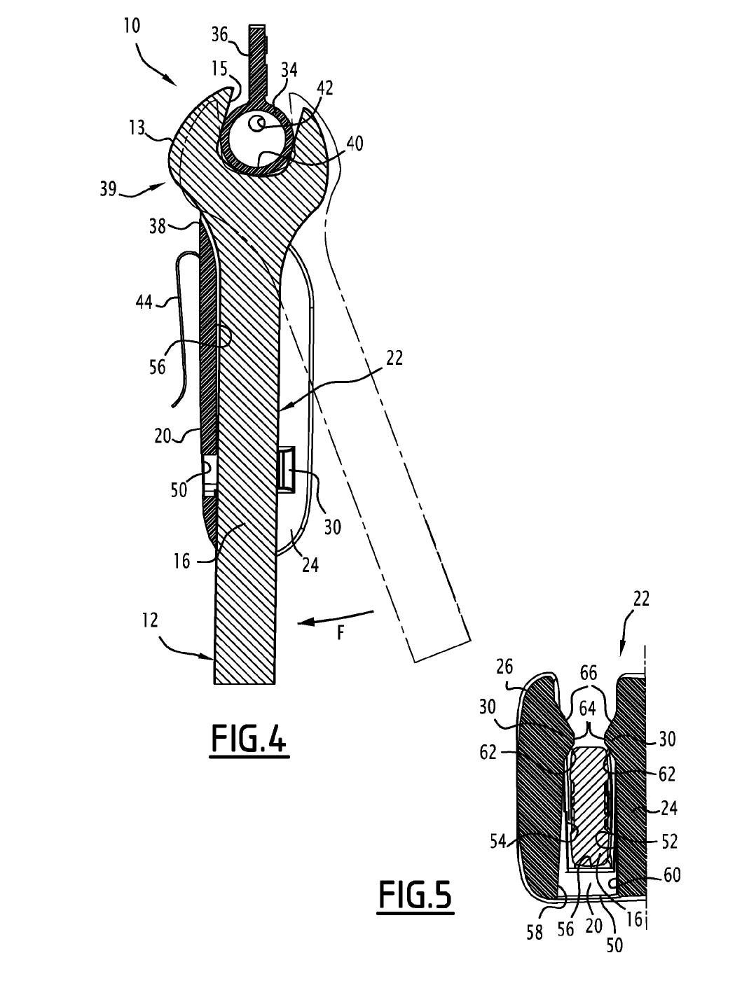

FIG. 4 is a cutaway view along line IV-IV of FIG. 3;

FIG. 5 is a cutaway view on an enlarged scale along line V-V of FIG. 3;

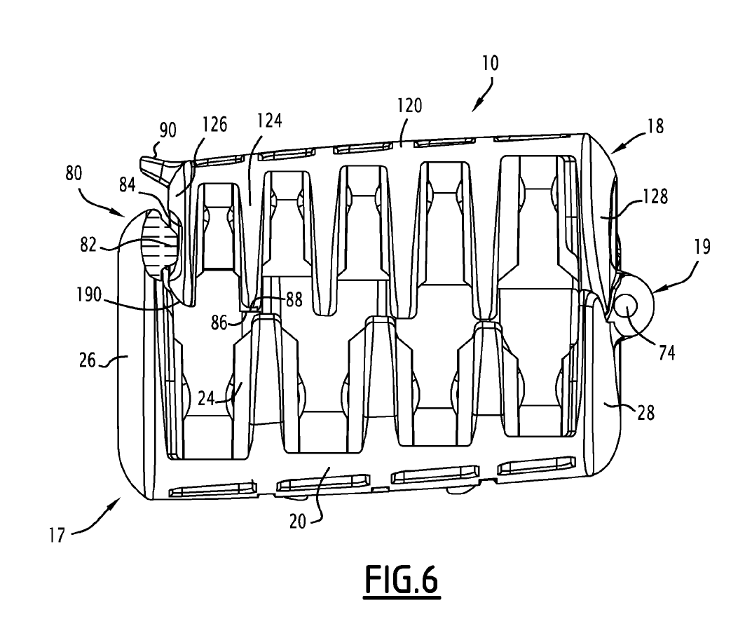

FIG. 6 is an end view of the case for a set of tools according to the invention in the storage and transport position;

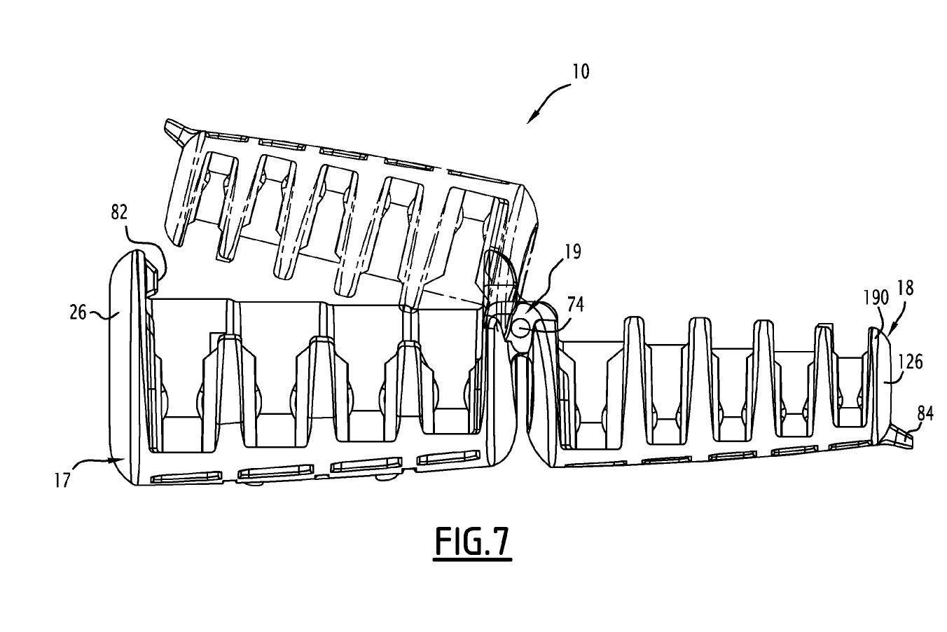

FIG. 7 is an end view of the case for a set of tools according to the invention in the position giving access to the set of tools;

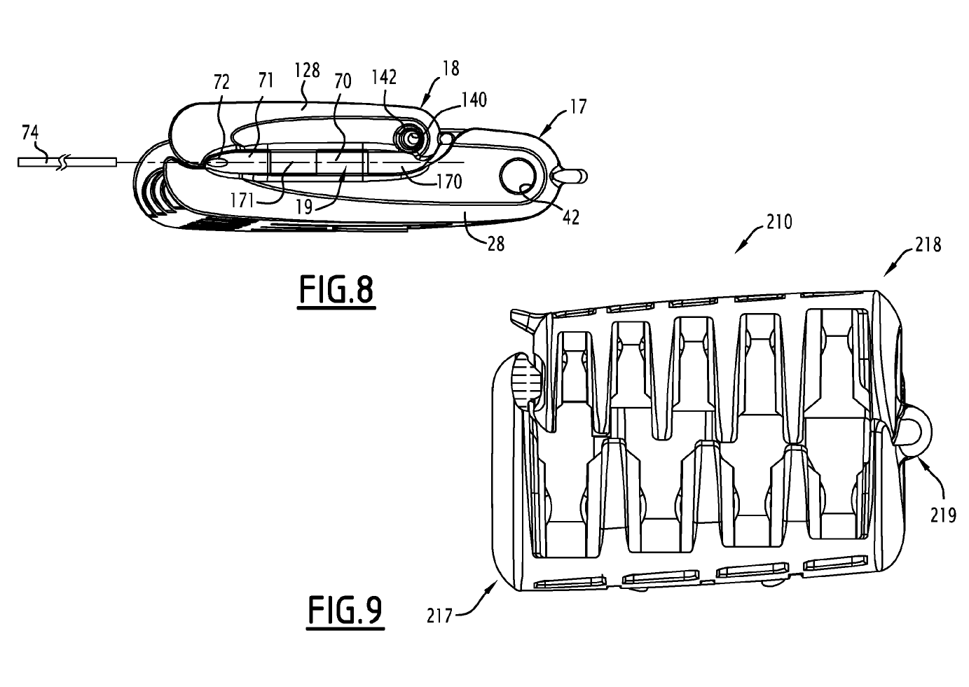

FIG. 8 is a side view of the case for a set of tools according to the invention; and

FIG. 9 is an end view of a second embodiment of the case for a set of tools according to the invention.

FIGS. 1 to 8 show a support 10 for a set of tools 12 (FIG. 3), in particular for open-end spanners, each tool comprising at least one working head 13 and 14 and a handle 16, the head 13 comprising a female internal recess 15 of the type having an open profile in claw form, and the head 14 being of the type having a closed profile in ring form in the example shown in FIG. 3.

The support 10 comprises a first support 17 and a second support 18. The first support 17 is a large support suitable for receiving a set of large tools. The second support 18 is a small support suitable for receiving a set of small tools. A hinge 19 connects the supports 17 and 18 with each other between a first, storage and transport position and a second position giving access to the tools (FIGS. 2, 3 and 6 to 8).

Each of the two supports 17 and 18 is a separate part moulded in one piece by thermoplastic injection from a thermoplastic elastomeric material which is, for example, a thermoplastic elastomer having a hardness of from 50 Shore D to 90 Shore D.

The first support 17 comprises a generally substantially planar base 20 in trapezoidal form.

A plurality of receivers 22, in the example shown four receivers 22, extend parallel to one another from the base 20, each receiver being intended to receive and retain the handle 16 of a corresponding tool of the set in a given position in the support 10.

A plurality of receiving and retaining means 32 for the tool head 13 extends substantially perpendicularly to the receivers 22, each receiving and retaining means 32 being associated with a receiver 22 and being intended to receive and retain the working head 13 of the corresponding tool 12 in a given position in the support 10.

The receivers 22 and the receiving and retaining means 32 are integral with the base 20.

The middle receivers 22 comprise solid partitions 24 which are substantially parallel to one another and delimit a channel 22. The outer partitions of the two end receivers form outer lateral walls 26, 28, respectively.

The lateral walls 26 and 28 connect the base 20 to the receiving and retaining means 32 and are disposed in the region of the bases in trapezoidal form. The longitudinal dimension of the wall 28 is accordingly smaller than that of the wall 26.

The partitions 24 and the two lateral walls 26 and 28 have been formed in one piece with the base 20, project substantially perpendicularly to the base, on the same face thereof, and each comprise a means 30 for positioning the handle 16. The means 30 is formed by a boss 30 which has been formed in one piece with the partition 24 and/or the lateral wall 26 or 28 carrying it and is disposed to project transversely into the channel 22.

The tool head receiving and retaining means 32 have also been formed in one piece with the base 20 and comprise a stepped bar 32 which is hollow and of generally substantially conical shape and which extends substantially perpendicularly to the longitudinal direction of the channels 22. A portion 34, of a size that is complementary to the size of the female internal recess 15 of a tool head 13 of the set of tools, defines one step of the bar 32. Each portion 34 is at a distance from the base 20 and retains the claw 13 transversely relative to the bar 32.

A step of the bar 32 is disposed substantially in the same plane as the associated receiver 22 of the handle 16 of a corresponding tool 12, and the bar 32 has sections progressively increasing from one portion 34 to the next.

The stepped bar 32 is extended in the longitudinal direction of the channels 22 by a projecting tab 36. A mark 37, formed in one piece with the tab 36, is disposed opposite each portion 34 of the stepped bar 32. Each mark 37 indicates the size of the opening of the female internal profile 15 of the head 13 of the tool 12.

The base 20 further comprises a tapered end 38 (FIG. 2) which faces the bar 32 and is spaced therefrom by a receiving space 39 for the tool head 13, as will be described hereinbelow.

The hollow bar 32 opens into each of the lateral walls 26 and 28 in the region of respective orifices 40 and 42 (FIGS. 4 and 8).

A metal clip 44 (FIG. 4), positioned on the rear face of the base 20, is attached and fixed by a fixing element (not shown), which is itself screwed into a blind hole (not shown). The clip 44 allows the case to be attached to the belt of a user.

A hole 48 is provided in the prolongation of one of the partitions 24 and is of such a size that a pin of a sales display can pass right through the base 20. The case 10 accordingly forms part of the sales packaging of the set of tools.

As is shown more particularly in FIGS. 2, 4 and 5, holes 50 formed in the base 20 opposite the positioning bosses 30 that project transversely into the channels 22 permit, during thermoplastic injection, the passage of pins allowing a portion of each boss 30 to be moulded.

FIG. 5 shows a section on an enlarged scale relating to the zone of the bosses 30. It shows an end channel 22 in which there is inserted a tool handle 16. A first boss 30 projects transversely into the channel 22 from the lateral wall 26. A second boss 30 projects into the channel 22 from the partition 24. Two surfaces 52 and 54 delimit the channel 22 laterally, the base 20 delimiting the bottom surface 56 of the channel 22. The surfaces 52 and 54 are tapered slightly in order to permit removal from the mould during thermoplastic injection.

In the prolongation of the hole 50, two surfaces 58 and 60, which are substantially planar and are inversely tapered relative to the surfaces 52 and 54, extend beyond half of the height of the lateral wall 26 and the partition 24, respectively, in the direction towards the free end of said lateral wall and partition. Each of the surfaces 58 and 60 is extended by a sloping surface 62, the surfaces 62 converging towards the centre of the channel. In the longitudinal axis of the channel 22, each of the sloping surfaces 62 is extended in the direction towards the free end of the wall 26 and of the partition 24 by two planar and parallel surfaces 64. Still in the direction towards the free end of the lateral wall 26 and of the partition 24, each of the planar surfaces 64 is extended by a sloping surface 66, the surfaces 66 diverging relative to the centre of the channel in the direction towards the free end of the lateral wall 26 and of the partition 24.

The surfaces 62, 64 and 66 form retaining, connecting and entry surfaces, respectively, of the bosses 30. The distance between the connecting surfaces 64 is smaller than the smallest dimension of the cross-section of the handle 16, so that the retaining surfaces 62 are suitable for retaining the handle of the tool.

The positioning of an open-end spanner 12 will now be described with reference to FIG. 4. This figure shows, in dot-and-dash lines, a first stage of the positioning of an open-end spanner 12 on the tool support 10. The claw 13 of the tool 12 is positioned on the portion 34 corresponding to the opening dimension of the female internal profile 15 of the tool 12, so that the claw 13 straddles the associated portion 34.

One of the jaws of the claw 13 is introduced into the receiving space 39 separating the base 20 from the bar 32, the internal profile 15 adapting itself on the portion 34 of complementary size of the bar 32.

The handle 16 then forms an angle with the longitudinal direction of the channel 22 of the support 10. Because the cross-section of the portion 34 is substantially circular, the spanner 12 is then able to rotate about a centre of rotation defined by the centre of the cross-section of the portion 34 straddled by the claw 13. In a rotary movement which tends to bring the handle 16 closer to the channel 22 (arrow F in FIG. 4), the operator engages the handle 16 in the channel 22 and brings the handle 16 into contact with the sloping entry surfaces 66 of the boss 30. Under the effect of the advancement of the handle 16, and by the effect of resilience of the partition 24 and/or of the wall 26, the entry surfaces 66 move apart, taking with them the connecting surfaces 64, on which the handle 16 slides. The partitions 24 and the lateral walls 26 and 28 are, in fact, capable of bending resiliently and transversely in order to allow the handle 16 to pass over the positioning bosses 30 of the handle.

After passing over the connecting surfaces 64 of the bosses 30, the handle 16 abuts the bottom 56 of the channel 22 and the retaining surfaces 62 retain the handle 16 in the associated receiver 22, with play.

The width of each channel 22 is slightly greater than the smallest dimension of the handle 16 of the associated tool 12. Accordingly, the partition 24 and the lateral wall 26 bend resiliently from their initial, non-stressed position and return, once the handle 16 has passed over the positioning bosses 30, to their initial position, even if the adjacent receivers are occupied by other tools. Accordingly, the partition 24 and the lateral wall 26 are subjected to bending stresses only when the handle 16 passes over the positioning boss 30, which improves the resistance of the plastics material over time. Consequently, the handle 16 is retained in its receiver with slight play in the two directions of its cross-section.

In the position in which the handle 16 is retained, the end 38 of the base 20 forms a retaining stop for the external profile of the tool head 13. Accordingly, the head 13 is retained transversely by the bar 32 and longitudinally by the stop 38, the latter effectively opposing the movement of the tool 12 in longitudinal translation relative to the channel 22.

The outer lateral wall 28 of the first support 17, which is located on the side of the smallest of the large tools, is extended, perpendicularly to the base 20 and laterally towards the outside, by an upper knuckle 70 and a lower knuckle 71 through which extend coaxial vertical bores 72 (FIG. 8).

The structure of the second support 18 is similar to that of first support 17. In the following description, elements of the structure of the second support 18 that have the same function as those described above for the structure of the first support 17 retain the reference numerals, increased by 100.

The second support 18 nevertheless differs from the first support 17 in that the number of receivers, in the example shown, is five. It also differs in that the outer lateral wall 128 of the second support 18, which is located on the side of the largest of the small tools, is extended, perpendicularly to the base 120 and laterally towards the outside, by an upper knuckle 170 and a lower knuckle 171, the upper knuckle 170 of the second support 18 having a blind bore (not shown) which is open to the bottom.

As will be seen in FIGS. 2 and 8, in order to assemble the case the two supports 17 and 18 are brought approximately into alignment with one another and are brought together in order to engage the knuckles 70, 71, 170 and 171, and a separate metal pin 74 is introduced through the bores and, by force, into the blind bore of the upper knuckle 170 of the second support 18.

The supports of the case 10 are then able to open and close in the manner of a wallet in order to assume two main positions:

(1) a first position, called the storage and transport position (FIGS. 1, 6, 8 and 9), in which the case is folded about the pin 74, the bases 20 and 120 being disposed externally and opposite one another, and the respective channels 24 and 124 of the receivers 22 and 122 of the first and second supports 17 and 18 being superposed facing one another;

(2) a second position, called the tool access position (FIGS. 2, 3 and 7), in which the first and second supports are opened flat in the manner of a wallet, the bases 20 and 120 being disposed substantially in the same plane and the respective channels 24 and 124 of the receivers 22 and 122 of the first and second supports 17 and 18 being side by side and parallel to one another.

In the first position, the tools of the set are arranged, the handles being disposed substantially vertically in their respective channels, in two half-sets of tools comprising four and five tools, superposed according to two substantially parallel planes, which increases the compactness of the case according to the invention as compared with a conventional rack.

In the second position, the tools of the set are arranged, the handles still being disposed substantially vertically in their respective channels, in a single set of tools comprising nine tools, which are aligned substantially according to a single plane, especially in decreasing tool size order for each support, which improves access to all the tools in the case as compared with a conventional rack.

As will be seen in FIG. 3, the free ends 14 of the two sets of tools substantially define, for each support, a sloping line L1, L2. Those two lines are offset relative to one another in the longitudinal direction of the tools. In view of the fact that the tools are arranged in decreasing size order in the second, tool access position, the largest tool of one of the supports is located, when the case is in the closed position corresponding to the first, so-called storage and transport position (FIG. 6), opposite the smallest tool of the other support, their free ends 14 being offset according to the longitudinal direction of the tools. This allows the compactness of the assembly when the case is in the closed position to be increased.

As is shown in FIG. 6, the case 10 further comprises a device 80 for locking the supports 17 and 18 together in their first, storage and transport position. Locking is effected by clipping.

A boss 82, formed in one piece with the outer lateral wall 26 of the first support 17 opposite the articulation 19, is arranged to project internally from the lateral wall 26, that is to say from the side of the channels 24 of the receivers 22.

A local recess 84, formed in one piece with the outer lateral wall 126 of the second support 18 opposite the articulation 19, is arranged on the outer surface of the lateral wall 126.

The boss 82 and the recess 84 cooperate owing to the resilience of the material from which the supports 17 and 18 are injection moulded.

When the second support 18 moves from the second, flat position to the first, folded position (FIG. 7), the lateral wall 126 of the second support 18 is in an offset position relative to the lateral wall 26 of the first support 17, so that the outer face of the lateral wall 126 is positioned on the inside of the lateral wall 26 of the first support 17.

The free end 190 of the lateral wall 126 comes into contact with the boss 82 and, owing to the resilience of the material, the lateral wall 26 of the first support 17 bends slightly in order to allow the free end 190 to surmount the boss 82 and engage in the local recess 84. The case is thus locked in the storage and transport position, the supports 17 and 18 being in abutment with one another by way of two planar portions 86 and 88 formed on the partitions 24 and 124, respectively, of the supports 17 and 18, the partitions 24 and 124 being those which are furthest from the articulation 19.

In order to open the case 10, the user has a local protuberance 90 in the form of a tab, which is arranged to project laterally outwards from the outer lateral wall 126 of the second support 18 and substantially in the prolongation of the base 120 of the second support 18.

It is to be noted that, in the first, storage position as shown in FIGS. 6 and 8, the outer lateral walls 28 and 128 of the first and second supports 17 and 18, respectively, arranged on the side of the articulation 19, are superposed (FIG. 6) and nested (FIG. 7) in an advantageous manner. Only the hinge 19 of rounded form projects laterally from the median portion of the re-formed outer wall of the articulation 19, which does not interfere with the handling ergonomics of the case.

When the user wishes to open the folded case, he grasps the first support 17 in the palm of one hand. This is facilitated by the width of the first support, which is adapted to the user's palm. The user grasps the second support 18 between the thumb and the other fingers of his other hand. He then acts on the protuberance 90 in the form of a tab in order to apply a force, which tends to separate the second support 18 from the first support 17 by rotation about the pin 74. Handling of the case is easy both for opening and for closing.

A second embodiment, shown in FIG. 9, differs from that shown in FIGS. 1 to 8 in that the case 210 comprises a first support and a second support 217 and 218 which have been formed in one piece by thermoplastic injection and are connected by a hinge 219 which has likewise been formed in one piece. The case 210 does not require assembly of the hinge as in the embodiment described hereinbefore, and its assembly cost is therefore lower.

The case according to the invention, which is made of thermoplastic material, has forms which are rounded and therefore not aggressive to a user. The case according to the invention thus has a feature of improved ergonomics.

In addition, the design of the case, which is of small size and can open and close in the manner of a wallet, improves its compactness while ensuring that its manufacturing cost is low.

1-13. (canceled)

14. Case for a set of tools, in particular for open-end spanners or ring spanners, each tool comprising at least one working head and a flat handle, the case comprising:
a first support and a second support which are articulated with one another by way of an articulation between a first, storage and transport position and a second, tool access position, each of the first and second supports comprising:
a base of generally substantially planar form;
a plurality of receivers, parallel to one another, each plurality of receivers being integral with the base of the corresponding support,
each receiver comprising two partitions which are substantially parallel to one another and delimit a channel for receiving and retaining the handle of a corresponding tool of the set in a given position in the first support or in the second support; wherein the width of each channel is slightly greater than the smallest dimension of the handle of the associated tool so that, in each channel, the tool handle is disposed substantially vertically, and each support comprises a plurality of receiving and retaining means for the working head of the tool, each receiving and retaining means being associated with a receiver and being intended to receive and retain the working head of the corresponding tool in a given position in the support, the plurality of receiving and retaining means being integral with the base; wherein, in the first, storage and transport position, the supports are folded on one another, the bases being disposed externally and opposed to each other and the channels of the receivers being superposed facing one another; and wherein each support is a part moulded from plastics material.

15. Case according to claim 14, wherein the plurality of receiving and retaining means are formed in one piece with the base.

16. Case according to claim 14, wherein, in the second, tool access position, the first support and the second support are opened flat in the manner of a wallet, the bases being disposed substantially in the same plane, and, in the second, tool access position, the channels of the receivers of the first and second supports are disposed side by side, parallel to one another.

17. Case according to claim 14, wherein the first support and the second support are constituted by separate parts, the first support being a large support suitable for receiving a set of large tools and the second support being a small support suitable for receiving a set of small tools.

18. Case according to claim 17, wherein each support comprises at least one lateral wall, preferably two lateral walls, formed in one piece with each base, which delimit(s) externally a or the end receiver(s), the outer lateral wall of the small support located on the side of the largest of the small tools being articulated with the outer lateral wall of the large support located on the side of the smallest of the large tools.

19. Case according to claim 17, wherein the first support and the second support are articulated with one another by way of a separate metal pin.

20. Case according to claim 15, wherein a clipping device locks the first support to the second support in its first folded storage and transport position.

21. Case according to claim 20, wherein the first support comprises an outer lateral wall disposed opposite the articulation, on which outer wall of the first support there is provided on the inner side a boss formed in one piece with the wall carrying it, and the second support comprises an outer lateral wall, likewise disposed opposite the articulation, on which outer wall of the second support there is provided on the outer side a recess formed in one piece with the wall carrying it, said boss cooperating with said recess in order to allow the first support to be locked to the second support by a snap-fit.

22. Case according to claim 15, wherein at least one of the partitions comprises a means for positioning the handle, and at least one partition of each channel, formed in one piece with the base, is suitable for bending resiliently and transversely in order to allow the handle to pass over the positioning means for the handle.

23. Case according to claim 15, wherein each support comprises at least one lateral wall formed in one piece with each base, which delimit(s) externally a or the end receiver(s), and the lateral walls join the base to said plurality of receiving and retaining means.

24. Case according to claim 23, wherein each support comprises two lateral walls.

25. Case according to claim 15, wherein the receiving and retaining means comprise a stepped bar which extends substantially perpendicularly to the longitudinal direction of the channels.

26. Tool set comprising a set of tools, in particular open-end spanners or ring spanners, each tool comprising at least one working head and a flat handle, the set of tools being arranged in a case, the case comprising:
a first support and a second support which are articulated with one another by way of an articulation between a first, storage and transport position and a second, tool access position, each of the first and second supports comprising:
a base of generally substantially planar form;
a plurality of receivers, parallel to one another, each plurality of receivers being integral with the base of the corresponding support,
each receiver comprising two partitions which are substantially parallel to one another and delimit a channel for receiving and retaining the handle of a corresponding tool of the set in a given position in the first support or in the second support; wherein the width of each channel is slightly greater than the smallest dimension of the handle of the associated tool so that, in each channel, the tool handle is disposed substantially vertically, and each support comprises a plurality of receiving and retaining means for the working head of the tool, each receiving and retaining means being associated with a receiver and being intended to receive and retain the working head of the corresponding tool in a given position in the support, the plurality of receiving and retaining means being integral with the base; wherein, in the first, storage and transport position, the supports are folded on one another, the bases being disposed externally and opposed to each other and the channels of the receivers being superposed facing one another; and wherein each support is a part moulded from plastics material,
wherein, when the case is in the second position, the free ends of the tools substantially define, for each support, a sloping line, the two lines being offset relative to one another in the longitudinal direction of the tools.
